(19) United States
(12) Patent Application Publication
(10) Pub. No.: US 2006/0025995 A1
(43) Pub. Date: Feb. 2, 2006

(54) Method and apparatus for natural language call routing using confidence scores

(76) Inventors: George W. Erhart, Pataskala, OH (US); Valentine C. Matula, Granville, OH (US); David Skiba, Golden, CO (US); Na'im Tyson, Mount Vernon, NY (US)

Correspondence Address: Ryan, Mason & Lewis, LLP;Suite 205, 1300 Post Road, Fairfield, CT, 06824, US

(21) Appl. No.: 10/901,556

(22) Filed: Jul. 29, 2004

(51) Int. Cl. G10L 15/08

(52) U.S. Cl. 704/239

(57) ABSTRACT

Methods and apparatus are provided for classifying a spoken utterance into at least one of a plurality of categories. A spoken utterance is translated into text and a confidence score is provided for one or more terms in the translation. The spoken utterance is classified into at least one category, based upon (i) a closeness measure between terms in the translation of the spoken utterance and terms in the at least one category and (ii) the confidence score. The closeness measure may be, for example, a measure of a cosine similarity between a query vector representation of said spoken utterance and each of said plurality of categories. A score is optionally generated for each of the plurality of categories and the score is used to classify the spoken utterance into at least one category. The confidence score for a multi-word term can be computed, for example, as a geometric mean of the confidence score for each individual word in the multi-word term.

### FIELD OF THE INVENTION

The present invention relates generally to methods and systems that classify spoken utterances or text into one of several subject areas, and more particularly, to methods and apparatus for classifying spoken utterances using Natural Language Call Routing techniques.

### BACKGROUND OF THE INVENTION

Many companies employ contact centers to exchange information with customers, typically as part of their Customer Relationship Management (CRM) programs. Automated systems, such as interactive voice response (IVR) systems, are often used to provide customers with information in the form of recorded messages and to obtain information from customers using keypad or voice responses to recorded queries.

When a customer contacts a company, a classification system, such as a Natural Language Call Routing (NLCR) system, is often employed to classify spoken utterances or text received from the customer into one of several subject areas or classes. In the case of spoken utterances, the classification system must first convert the speech to text using a speech recognition engine, often referred to as an Automatic Speech Recognizer (ASR). Once the communication is classified into a particular subject area, the communication can be routed to an appropriate call center agent, response team or virtual agent (e.g., a self service application), as appropriate. For example, a telephone inquiry may be automatically routed to a given call center agent based on the expertise, skills or capabilities of the agent.

While such classification systems have significantly improved the ability of call centers to automatically route a telephone call to an appropriate destination, NCLR techniques suffer from a number of limitations, which if overcome, could significantly improve the efficiency and accuracy of call routing techniques in a call center. In particular, the accuracy of the call routing portion of NLCR applications is largely dependent on the accuracy of the automatic speech recognition module. In most NLCR applications, the sole purpose of the Automatic Speech Recognizer is to transcribe the user's spoken request into text, so that the user's desired destination can be determined from the transcribed text. Given the level of uncertainty in correctly recognizing words with an Automatic Speech Recognizer, calls can be incorrectly transcribed, raising the possibility that a caller will be routed to the wrong destination.

A need therefore exists for improved methods and systems for routing telephone calls that reduce the potential for errors in classification. A further need exists for improved methods and systems for routing telephone calls that compensate for uncertainties in the Automatic Speech Recognizer.

### SUMMARY OF THE INVENTION

Generally, methods and apparatus are provided for classifying a spoken utterance into at least one of a plurality of categories. A spoken utterance is translated into text and a confidence score is provided for one or more terms in the translation. The spoken utterance is classified into at least one category, based upon (i) a closeness measure between terms in the translation of the spoken utterance and terms in the at least one category and (ii) the confidence score. The closeness measure may be, for example, a measure of a cosine similarity between a query vector representation of said spoken utterance and each of said plurality of categories.

A score is optionally generated for each of the plurality of categories and the score is used to classify the spoken utterance into at least one category. The confidence score for a multi-word term can be computed, for example, as a geometric mean of the confidence score for each individual word in the multi-word term.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIGS. 2A and 2B are schematic block diagrams of a conventional classification system in a training mode and a run-time mode, respectively;

FIG. 3 is a schematic block diagram illustrating the conventional training process that performs preprocessing and training for the classifier of FIG. 2A; and

FIG. 4 is a flow chart describing an exemplary implementation of a classification process incorporating features of the present invention.

### DETAILED DESCRIPTION

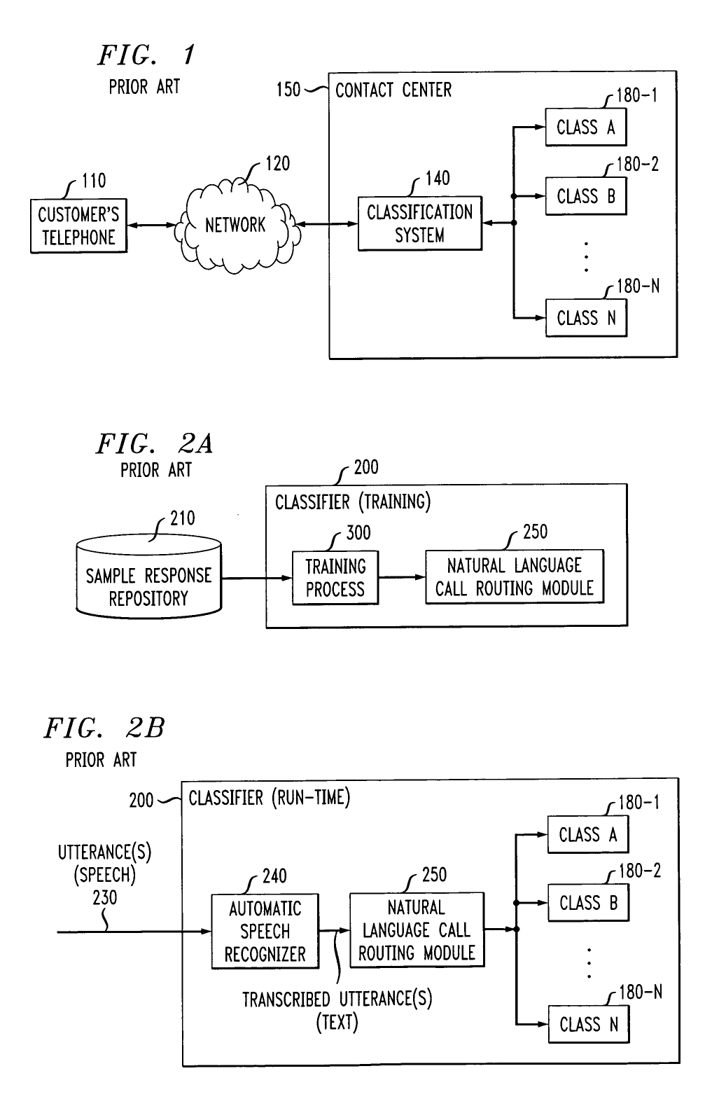

FIG. 1 illustrates a network environment in which the present invention can operate. As shown in FIG. 1, a customer, employing a telephone 110 or computing device (not shown), contacts a contact center 150, such as a call center operated by a company. The contact center 150 includes a classification system 200, discussed further below in conjunction with FIGS. 2A and 2B, that classifies the communication into one of several subject areas or classes 180-A through 180-N (hereinafter, collectively referred to as classes 180). Each class 180 may be associated, for example, with a given call center agent or response team and the communication may then be automatically routed to a given call center agent 180, for example, based on the expertise, skills or capabilities of the agent or team. It is noted that the call center agent or response teams need not be humans. In a further variation, the classification system 200 can classify the communication into an appropriate subject area or class for subsequent action by another person, group or computer process. The network 120 may be embodied as any private or public wired or wireless network, including the Public Switched Telephone Network, Private Branch Exchange switch, Internet, or cellular network, or some combination of the foregoing.

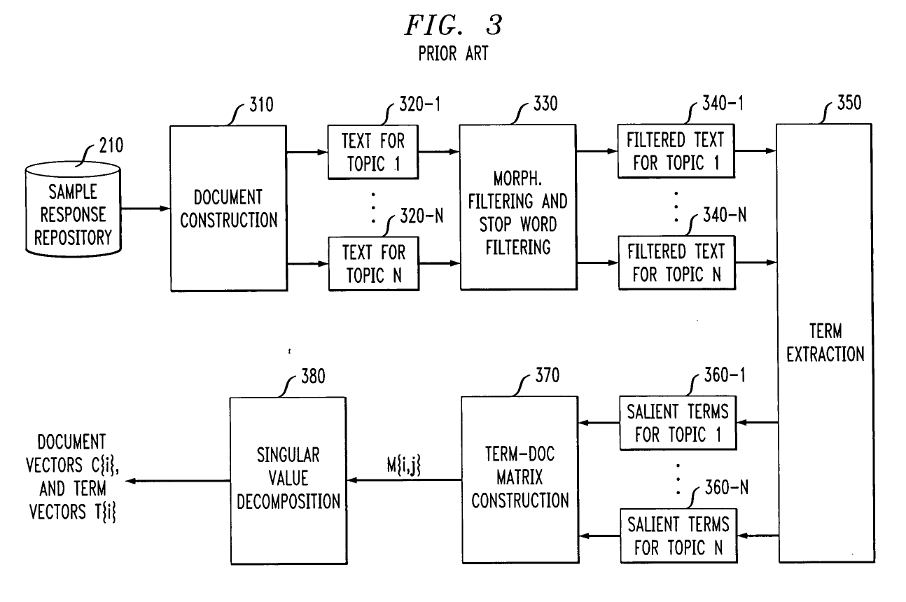

FIG. 2A is a schematic block diagram of a conventional classification system 200 in a training mode. As shown in FIG. 2A, the classification system 200 employs a sample response repository 210 that stores textual versions of sample responses that have been collected from various callers and previously transcribed and manually classified into one of several subject areas. The sample response repository 210 may be, for example, a domain specific collection of possible queries and associated potential answers, such as “How may I help you?” and each of the observed answers. The textual versions of the responses in the sample response repository 210 are automatically processed by a training process 300, as discussed further below in conjunction with FIG. 3, during the training mode to create the statistical-based Natural Language Call Routing module 250.

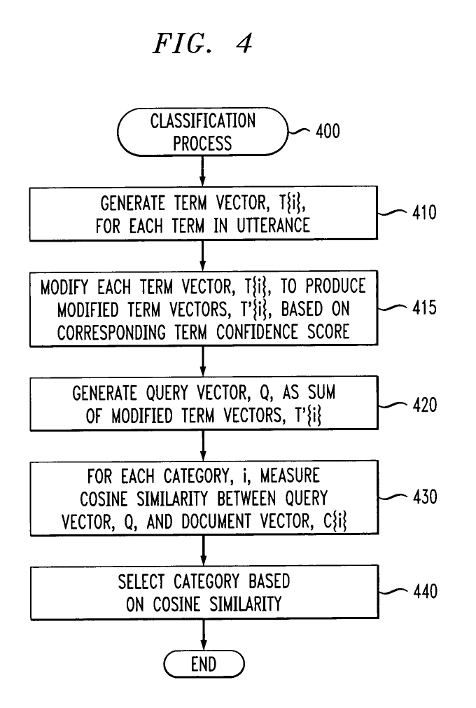

FIG. 2B is a schematic block diagram of a conventional classification system 200 in a run-time mode. When a new utterance 230 is received at run-time, the Automatic Speech Recognizer 240 transcribes the utterance to create a textual version and the trained Natural Language Call Routing module 250 classifies the utterance into the appropriate destination (e.g., class A to N). The Automatic Speech Recognizer 240 may be embodied as any commercially available speech recognition system, and may itself require training, as would be apparent to a person of ordinary skill in the art. As discussed further below in conjunction with FIG. 4, the conventional Natural Language Call Routing module 250 of the classification system 200 is modified in accordance with the present invention to incorporate confidence scores reported by the Automatic Speech Recognizer 240. The confidence scores are employed to reweigh the query vectors that are used to route the call.

In the exemplary embodiment described herein, the routing is implemented using Latent Semantic Indexing (LSI), which is a member of the general set of vector-based document classifiers. LSI techniques take a set of documents and the terms embodying them and construct term-document matrices, where rows in the matrix signify unique terms and columns are the documents (categories) consisting of those terms. Terms, in the exemplary embodiment, can be n-grams, where n is between one and three.

Generally, the classified textual versions of the responses 210 are processed by the training process 300 to look for patterns in the classifications that can subsequently be applied to classify new utterances. Each sample in the corpus 210 is “classified” by hand as to the routing destination for the utterance (i.e., if a live agent heard this response to a given question, where would the live agent route the call). The corpus of sample text and classification is analyzed during the training phase to create the internal classifier data structures that characterize the utterances and classes.

In one class of statistical-based natural language understanding modules 250, for example, the natural language understanding module 250 generally consists of a root word list comprised of a list of root words and a corresponding likelihood (percentage) that the root word should be routed to a given destination or category (e.g., a call center agent 180). In other words, for each root word, such as “credit” or “credit card payment,” the Natural Language Call Routing module 250 indicates the likelihood (typically on a percentage basis) that the root word should be routed to a given destination.

For a detailed discussion of suitable techniques for call routing and building a natural language understanding module 250, see, for example, B. Carpenter and J. Chu-Carroll, “Natural Language Call Routing: a Robust, Self-Organizing Approach,” Proc. of the Int'l Conf. on Speech and Language Processing, (1998); J. Chu-Carroll and R. L. Carpenter, “Vector-Based Natural Language Call Routing,” Computational Linguistics, vol. 25, no. 3, 361-388 (1999); or V. Matula, “Using NL to Speech-Enable Advocate and Interaction Center”, In AAU 2004, Session 624, Mar. 13, 2003, each incorporated by reference herein.

FIG. 3 is a schematic block diagram illustrating the conventional training process 300 that performs preprocessing and training for the classifier 200. As shown in FIG. 3, the classified utterances in the sample response repository 210 are processed during a document construction stage 310 to identify text for the various N topics 320-1 through 320-N. At stage 330, the text for topics 320-1 through 320-N are processed to produce the root word form and remove ignore words and stop words (such as “and” or “the”), and thereby produce filtered text for topics 340-1 through 340-N. The terms from the filtered text is processed at stage 350 to extract the unique terms, and the salient terms for each topic 360-1 through 360-N are obtained.

The salient terms for each topic 360-1 through 360-N are processed at stage 370 to produce the term-document matrix (TxD matrix). The term-document matrix is then decomposed into document (category) and term matrices at stage 380 using Singular Value Decomposition (SVD) techniques.

In the term-document matrix, M{i,j} (corresponding to the i-th term under the j-th category), each entry is assigned a weight based on the term frequency multiplied by the inverse document frequency (TFxIDF). Singular Value Decomposition (SVD) reduces the size of the document space by decomposing the matrix, M, thereupon producing a term vector for the i-th term, T{i}, and the i-th category vector, C{i}, which come together to form document vectors for use at the time of retrieval. For a more detailed discussion of LSI routing techniques, see, for example, J. Chu-Carroll and R. L. Carpenter, “Vector-Based Natural Language Call Routing,” Computational Linguistics, vol. 25, no. 3, 361-388 (1999); and L. Li and W. Chou, “Improving Latent Semantic Indexing Based Classifier with Information Gain,” Proc. ICSLP 2002, September. 2002; and Faloutsos and D. W. Oard, “A Survey of Information Retrieval and Filtering Methods,” (August 1995).

In order to classify a call, the caller's spoken request is transcribed (with errors) into text by the ASR engine 240. The text transcription becomes a pseudo-document, from which the most salient terms are extracted to form a query vector, Q (i.e., a summation of the term vectors that compose it). The classifier assigns a call destination to the pseudo-document using a closeness metrics that measures cosine similarity between the query vector, Q, and each destination, C{i}, i.e., cos(Q, C{i}). In one implementation, a sigmoid function properly fits cosine values to routing destinations. Although computing cosine similarity generates reasonably accurate results, the sigmoid fitting is necessary in cases where the cosine value does not yield the correct routing decision, but the categories might appear within a list of possible candidates.

Unlike earlier implementations of LSI for NLCR, where the classifier selected terms based upon their frequency of occurrence, in more recent implementations the salience of words available from term-document matrices is obtained by computing an information theoretic measure. This measure, known as the information gain (IG), is the degree of certainty gained about a category given the presence or absence of a particular term. See, Li and Chou, 2002. Calculating such a measure for terms in a set of training data produces a set of highly discriminative terms for populating in a term-document matrix. IG enhanced, LSI-based NLCR is similar to LSI with term counts in terms of computing cosine similarity between a user's request and a call category; but an LSI classifier with terms selected via IG reduces the amount of error in precision and recall by selecting a more discerning set of terms leading to potential caller destinations.

The present invention recognizes that regardless of whether a classifier selects terms to be retained in the term-document matrices based on term counts or information gain, there is additional information available from the ASR process 240 that is not used by the standard LSI-based query vector classification process. The ASR process 240 often misrecognizes one or more words in an utterance, which may have an adverse effect on the subsequent classification. The standard LSI classification process (regardless of term selection method) does not take advantage of information provided by the ASR, just the text transcription of the utterance. This can be a particularly hazardous problem if an IG-based LSI classifier is used, since the term selection process attempts to select terms with the highest information content or potential impact on the final routing decision. Misrecognizing any of those terms could lead to a caller being routed to the wrong destination.

Most commercial ASR engines provide information at the word level that can benefit an online NLCR application. Specifically, the engines return a confidence score for each recognized word, such as a value between 0 and 100. Here, 0 means that there is no confidence that the word is correct and 100 would indicate the highest level of assurance that the word has been correctly transcribed. In order to incorporate this additional information from the ASR process into the classification process, the confidence scores are used to influence the magnitude and direction of each term vector on the assumption that words with high confidence scores and term vector values should influence the final selection more than words with lower confidence scores and term vector values.

The confidence scores generated by the ASR 240 generally appear in the form of percentages. Thus, in the exemplary embodiment, a geometric mean, G, of the confidence scores that comprise a term are employed, which can be an n-gram with a length of at most three words, as follows:

$$G ( {w}_{1} , … , {w}_{n} ) = \sqrt[n]{{\prod }_{i = 1}^{n} Conf ( {w}_{i} )} \qquad ( 1 )$$

Here, the geometric mean of a term consisting of an n-gram is the n-th root of the product of the confidence scores for each word present in the term.

If the arithmetic mean of confidence scores comprising a term was computed, then it is possible that two terms have the same average with different confidence scores. For instance, one term could consist of a bigram, where each word has a confidence score of 50; and the other term has a bigram with one word having a confidence score of 90, while the other has a score of 10. Both terms then have the same arithmetic mean, thereby obscuring a term's contribution to the query vector.

Using the geometric mean, the confidence score can be multiplied by the value of the term vector T{i} to get a new term vector T′{i}. Finally, by summing over all the term vectors in a transcribed utterance a query vector Q, is obtained, as follows:

$$Q = {\sum }_{i = 1}^{n} {T}^{′} [ i ] \qquad ( 2 )$$

After this calculation, the procedure is the same as with the conventional approach. Take the query vector Q, measure the cosine similarity between the query vector Q, and each routing destination, and return a list of candidates in descending order.

Training ASR 240 and LSI Classifier 250

As previously indicated, the training phase for consists of two parts: training the speech recognizer 240 and training the call classifier 250. The speech recognizer 240 utilizes a statistical language model in order to produce a text transcription. It is trained with transcriptions of caller's utterances obtained manually. Once a statistical language model is obtained for the ASR engine 240 to use for recognition, this same set of caller utterance transcriptions is used to train the LSI classifier 250. Each utterance transcription has a corresponding routing location (or document class) assigned.

Instead of converting between formats for both the recognizer 240 and classifier 250, the training texts can remain in the format that was compliant with the commercial ASR engine 240. Accordingly, the formatting requirements of the speech recognizer 240 are employed and ran the manually acquired texts through a preprocessing stage. The same set of texts can be used for both the recognizer 240 and the routing module 250. After preparing the training texts, they were in turn fed to the LSI classifier to ultimately produce vectors available for comparison (as described in the previous section).

During the training phase 300 of the routing module 250, a validation process ensures the accuracy of the manually assigned topics for each utterance. To this end, one utterance can be removed from the training set and made available for testing. If there were any discrepancies between the assigned and resulting categories, they can be resolved by changing the assigned category (because it was incorrect) or adding more utterances of that category to ensure a correct result.

FIG. 4 is a flow chart describing an exemplary implementation of a classification process 400 incorporating features of the present invention. As shown in FIG. 4, the classification process 400 initially generates a term vector, T{i}, for each term in the utterance during step 410. Thereafter, each term vector, T{i}, is modified during step 415 to produce a set of modified term vectors, T′ {i}, based on the corresponding term confidence score. It is noted that in the exemplary embodiment, the confidence score for multi-word terms, such as “credit card account,” is the geometric mean of the confidence score for each individual word. Other variations are possible, as would be apparent to a person of ordinary skill in the art. The geometric mean of a multi-word term is used as a reflection of its contribution to the query vector.

A query vector, Q, for the utterance to be classified is generated during step 420 as a sum of the modified term vectors, T′ { }. Thereafter, during step 430, the cosine similarity is measured for each category, i, between the query vector, Q, and the document vector, C{i}. It is noted that other methods for measuring similarity can also be employed, such as Euclidian and Manhattan distance metrics, as would be apparent to a person of ordinary skill in the art. The category, i, with the maximum score is selected as the appropriate destination during step 440, before program control terminates.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for classifying a spoken utterance into at least one of a plurality of categories, comprising:
obtaining a translation of said spoken utterance into text;
obtaining a confidence score associated with one or more terms in said translation; and
classifying said spoken utterance into at least one category, based upon (i) a closeness measure between terms in said translation of said spoken utterance and terms in said at least one category and (ii) said confidence score.

2. The method of claim 1, wherein said closeness measure is a measure of a cosine similarity between a query vector representation of said spoken utterance and each of said plurality of categories.

3. The method of claim 1, wherein said classifying step performs a Latent Semantic Indexing (LSI) classification.

4. The method of claim 1, further comprising the step of processing classified utterances during a training mode.

5. The method of claim 1, wherein said classifying step employs a root word list comprised of a list of root words and a corresponding likelihood that the root word should be routed to a given one of said plurality of categories.

6. The method of claim 1, wherein said classifying step further comprises the step of generating a score for each of said plurality of categories.

7. The method of claim 6, wherein said classification of said spoken utterance into at least one category is based upon said generated score for each of said plurality of categories.

8. The method of claim 6, wherein said classification of said spoken utterance into at least one category generates an ordered list of said plurality of categories.

9. The method of claim 1, wherein said confidence scores for one or more terms in said translation is comprised of a confidence score for each term in said spoken utterance.

10. The method of claim 9, wherein said confidence score for a multi-word term is computed as a geometric mean of the confidence score for each individual word in said multi-word term.

11. A system for classifying a spoken utterance into at least one of a plurality of categories, comprising:
a memory; and
at least one processor, coupled to the memory, operative to:
obtain a translation of said spoken utterance into text;
obtain a confidence score associated with one or more terms in said translation; and
classify said spoken utterance into at least one category, based upon (i) a closeness measure between terms in said translation of said spoken utterance and terms in said at least one category and (ii) said confidence score.

12. The system of claim 11, wherein said closeness measure is a measure of a cosine similarity between a query vector representation of said spoken utterance and each of said plurality of categories.

13. The system of claim 11, wherein said processor is further configured to classify said spoken utterance using a Latent Semantic Indexing (LSI) classification.

14. The system of claim 11, wherein said processor is further configured to employ a root word list comprised of a list of root words and a corresponding likelihood that the root word should be routed to a given one of said plurality of categories.

15. The system of claim 11, wherein said processor is further configured to generate a score for each of said plurality of categories.

16. The system of claim 11, wherein said processor is further configured to generate an ordered list of said plurality of categories.

17. The system of claim 11, wherein said confidence score for a multi-word term is computed as a geometric mean of the confidence score for each individual word in said multi-word term.

18. An article of manufacture for classifying a spoken utterance into at least one of a plurality of categories, comprising a machine readable medium containing one or more programs which when executed implement the steps of:
obtaining a translation of said spoken utterance into text;
obtaining a confidence score associated with one or more terms in said translation; and
classifying said spoken utterance into at least one category, based upon (i) a closeness measure between terms in said translation of said spoken utterance and terms in said at least one category and (ii) said confidence score.

19. The article of manufacture of claim 18, wherein said confidence scores for one or more terms in said translation is comprised of a confidence score for each term in said spoken utterance.

20. The article of manufacture of claim 19, wherein said confidence score for a multi-word term is computed as a geometric mean of the confidence score for each individual word in said multi-word term.
